(19) United States
(12) Patent Application Publication
(10) Pub. No.: US 2024/0238704 A1
(43) Pub. Date: Jul. 18, 2024

(54) A SEPARATOR WITH FLOW MANAGEMENT

(71) Applicant: Inheriting Earth Limited, St Philips (GB)

(72) Inventors: Reuben D'Orton-Gibson, Bristol (GB); Michael Lawrance-Owen, Bristol (GB); Reuben Kettle Aiers, Bristol (GB); Fergal Feeney, Bristol (GB); Adam Root, Bristol (GB)

(73) Assignee: Inheriting Earth Limited, St Philips, BS (GB)

(21) Appl. No.: 18/557,979

(22) PCT Filed: Apr. 29, 2022
(86) PCT No.: PCT/EP22/61492

§ 371 Date: Oct. 30, 2023

(30) Foreign Application Priority Data
Apr. 30, 2021 (GB) 2106277.3
Nov. 12, 2021 (GB) 2116312.6

(51) Int. Cl. B01D 29/68; B01D 29/60; B01D 35/147; C02F 1/00; D06F 33/43; D06F 34/20; D06F 39/10; D06F 103/42; D06F 105/06; D06F 105/34

(52) U.S. Cl. CPC B01D 29/682; B01D 29/606; B01D 35/147; C02F 1/001; C02F 1/008; D06F 33/43; D06F 34/20; D06F 39/10; B01D 2201/084; C02F 2303/16; C02F 2307/12; D06F 2103/42; D06F 2105/06; D06F 2105/34

(57) ABSTRACT

A separator prevents microplastics from entering the environment by regenerating the pressure consumption of filters for removing microplastics in effluent from any source but in particular removing microfibers from washing machine wastewater. The separator includes a chamber with an inlet and an outlet, a sieve structure forming a permeable barrier between the inlet and the outlet to filter the effluent, the sieve structure thus having an inlet side for unfiltered effluent and an outlet side for filtered effluent, the separator further including at least one pump in fluid communication with the outlet of the chamber, and at least one sensor is provided, and wherein the pump is arranged to be activated in accordance with the output from the sensor.

### FIELD OF THE INVENTION

The invention relates to preventing microplastics from entering the environment. In particular the invention is directed to regenerating the pressure consumption of filters for removing microplastics in effluent from any source but in particular removing microfibers from washing machine wastewater.

### BACKGROUND

Microfibres are the most abundant form of microplastic pollution in rivers and oceans. Due to their microscopic scale, microfibers are eaten by organisms at all levels of the food chain, from plankton to top predators. Once ingested, plastics reduce feeding efficiency (false satiation) they may damage the gut of the animal and transfer harmful additives like PCBs, pesticides, flame retardants to the animal that consumed it. Plastics consumed by animals low in the food chain also impact their predators, which consume numerous contaminated prey daily. The pervasiveness of microfibers in the food chain has naturally resulted in concern regarding their transfer to humans, and contamination has been observed in crustaceans, molluscs and fish species destined for human consumption.

Unlike microbeads, which are easily excluded from toiletries and cleaning products, microfibres are formed through damage to clothing. One third of all microplastics in the oceans come from washing of synthetic textiles. Synthetic fabrics derived from petrochemicals make up 65% of all textiles. Wear and tear caused by abrasive forces in washing machines result in the fragmentation of man-made textiles, forming hundreds of thousands of microfibres, less than 5 mm in length, which leak from homes and drainage networks into the ocean.

The vast impact of microplastics on marine ecosystems is starting to be understood. A 2019 study published in the ‘Science of the Total Environment’ journal found 49% of 150 fish samples from the North East Atlantic Ocean contained microplastics with evidence of this causing harm to brain, gills, and dorsal muscles. These microplastics are also passed onto people consuming fish at a rate of between 518-3078 microplastic items/year/capita.

The impact is not just being seen in fish stocks but also algae, the building blocks of life. A 2015 study published in the ‘Aquatic Toxicology’ journal demonstrated high concentrations of polystyrene particles reduced algal growth up to 45%. This should be of concern as microalgae are one of the world's largest producers of oxygen on this planet.

Wastewater treatment plants cannot remove the millions of fibres that pass through them every day. Currently, secondary level water treatment removes around 98% of the microplastics that pass through them. However, the small proportion that escapes still equates to tens of millions of fibres per treatment works per day.

Furthermore, wastewater treatment plants produce a “sewage sludge” and plastic microfibers are found on discharge when released into the natural environment when the sludge is spread on agricultural land, thus microfibers make their way into the food chain, waste to energy (which can destroy fibres but release harmful gasses) or discharged into rivers or the ocean.

Current washing machine filters are designed to stop pennies and buttons breaking the washing machine pump. The filtration required to stop microfibres is less than 50 micrometers (μm), which is about the width of a human hair.

It is known to provide mesh filters that stop the problem at source. However, mesh filters clog up quickly and when this happens their effectiveness drops off considerably. This causes the pressure to drop and the flow rate to reduce, which can lead to damage to pumps and other elements of the system and flooding.

A typical front-loading domestic washing machine is shown in FIG. 1 in schematic form. The machine 100 includes a rotatable sealed drum unit 101 for receiving garments to be washed. The drum unit 101 has a perforated cylindrical rotatable drum mounted inside a static waterproof shroud. Clean water is fed into the drum 101 via a cold water or hot water inlet 102 connected to mains and under mains pressure of typically 1-5 bar. The water entering the drum 101 is managed by an electronic valve, under the control of a CPU 104. The inlet 102 is connected to a drawer 105 where liquid or powdered detergent can be added by a user. The drawer has an outlet that leads to the drum unit 101. The drum unit may include a heater under the control of the CPU to heat the water to the desired wash temperature, typically up to 90 degrees Celsius. The drum is rotatable by an electric motor 106 under the control of the CPU 104 at speeds of typically from 5 to 1600 rpm. The drum unit can be emptied via a drain pump 108 controlled by the CPU. The drain pump is rated with a given power to produce a known pressure at its output. The drain pump feeds into an outlet 109, which is connected to the household or industrial drain and eventually the wastewater network.

A typical top-loading machine will have the axis of the drum vertical but will otherwise share many of the features of the front-loading machine.

In use, dirty laundry is placed in the drum, and a wash cycle initiated by a user. The CPU allows cold water to flow via the drawer to mix with detergent and then on into the drum, where the water is heated. The combined water, detergent and laundry is agitated by rotating the drum. During this process, dirt and grease is released into the water and fibres from the clothing too. If the clothing is synthetic, microfibers are typically released as the clothes rub against each other. The resulting effluent at the end of the wash cycle is a mixture of debris, dirt, grease and microfibers and potentially large objects such as coins or nails left in the clothing. This effluent is then drained and pumped out of the drum at a typical rate of 3-8 gallons per minute. Second or third rinse cycles with clean water may be performed, resulting in effluent with less concentrated contaminants. The drain rate of the washing machine is impacted by the level of water in the drum, the height of the outlet point and if a filter is connected to the outlet.

In a typical wash, the highest concentration of microfibers is in the range 5 mm to 50 μm but shorter microfibers exist that are still harmful in the environment. If it were required to remove 99% of microfibers of all sizes down to 50 μm in length, a mesh with apertures of 25 μm would theoretically be able to achieve this. In practice however, such a mesh placed directly in the stream of effluent will clog almost immediately and the filter will become inoperable. This will create a rise in pressure consumption in the outlet and potentially damage the pump.

A conventional separator or filter arrangement is shown in FIG. 2. An inlet 201 directs effluent into a filter housing 202, within which a sieve structure 203 is supported. The sieve structure could be a mesh or other perforated material where the mesh opening size is selected to trap particles of a required dimension. Filtered effluent passes through the sieve structure 203 to an outlet 204. The filtered waste accumulates on what is called the unfiltered side of the sieve structure, while the outlet side of the sieve structure is called the filtered side. Filter efficacy is its effectiveness at removing debris of a given size range while maintaining an acceptable flow rate and is closely related to the filter's pressure consumption. The sieve structure shown in FIG. 2 will become blinded over by filtered debris rapidly, so that its pressure consumption will increase.

Curve 1 in FIG. 3 is a measure of the effectiveness of the arrangement shown in FIG. 2, given a constant flow of dirty water, with a consistent contamination level. The y-axis represents the fluid pressure, P, at the inlet 201 and it can be seen to rise gradually, then exponentially as the mesh becomes blinded over with filtrate.

In practice, the flow of effluent from a washing machine is not constant over time because a limited amount of water is used in each wash cycle. Curve 2 in FIG. 3 shows how the inlet pressure varies over time where the flow of effluent stops, drains through the device and then starts again. Reductions in the pressure can be seen, as the flow stops and debris previously held against the mesh by the pressure of the flow falls away, revealing pores that allow fluid to flow through again, until they become re-blocked in the next cycle. Curve 2 demonstrates that the pressure consumption required by the conventional device increases through use, so the inlet pressure required to filter effluent eventually becomes greater than the pump is able to provide.

To operate a filter at its optimum level requires the pressure to be regenerated when required. It is an object of the invention to solve the problem of optimising the pressure regeneration process.

### SUMMARY OF THE INVENTION

In an embodiment, a separator for separating solid material from a fluid is provided, the separator comprising: a chamber with an inlet and an outlet, a sieve structure forming a permeable barrier between the inlet and the outlet to filter the fluid, the sieve structure thus having an inlet side for unfiltered fluid and an outlet side for filtered fluid,
wherein the separator further comprises a filter pressure regeneration apparatus for dislodging filtered material from the sieve structure,
wherein the filter pressure regeneration apparatus comprises a conduit and a nozzle assembly having at least one cleaning jet directed towards the outlet side of the sieve structure, wherein the filter pressure regeneration apparatus is arranged to be fed from a cleaning fluid source,
the separator characterised in that the sieve structure has a circular cross-section, and wherein a channel is formed between the chamber and the sieve structure such that in use the fluid is guided circumferentially around the sieve structure through the channel,
the separator further having a sensor arranged to sense a state of the separator, and wherein the cleaning fluid source is arranged to be activated in accordance with the output from the sensor. The cleaning fluid source could be a pump recirculating filtered water or mains pressure fed water,
wherein the wash water is activated to clean the filtered fluid off the mesh. The logic of this can be controlled by time, pressure across the mesh or a fluid sensor. The description herein is directed towards filtering microplastics from effluent, but the separator may be applied to separate any solid material from any fluid.

The sensor may be located at the inlet or at the outlet.

The pressure sensor may detect pressure from the inlet to the outlet to determine pressure across the separator.

A reservoir may be provided below the chamber and the sensor may be located in the reservoir. The sensor may also be located at the conduit that feeds the inlet to the filter, the outlet to the filter or where a bypass conduit may be located.

Some detector types, such as a pressure differential sensor may use multiple locations to provide differential measurements whereas others may only require a single location.

The reservoir may have a main outlet and a drain outlet for draining the reservoir below the main outlet and wherein the fluid detector is located in proximity to the drain outlet.

The sensor may be a fluid detector such as a float switch or a capacitative sensor. The sensor may be a pressure sensor for sensing the pressure differential between the unfiltered and filtered sides of the sieve structure.

The chamber may be cylindrical and the sieve structure may be a coaxial cylinder within the chamber and wherein a wall may be provide to one side of the inlet such that the fluid is guided around the sieve structure through a channel such that filtered solids dislodged by cleaning fluid from the cleaning nozzle accumulates on the side of the wall away from the inlet. The advantage of this arrangement, whereby filtered solid materials progress along a channel, is the better use of space, increased solid material collection capacity and ease of handling filtered solids.

A trap may be provided comprising an opening in the base of the channel to a sub-chamber, where the accumulating filtered solids can be collected.

The nozzle assembly may comprise a plurality of cleaning nozzles that are rotatable around the central axis of the sieve structure.

The nozzle assembly may be rotated by propulsion nozzles arranged to direct a stream of water. The nozzles may be arranged off-centre from the central axis to provide propulsion or have a vector that is offset from the central axis or is tangential to the circumference of the sieve structure.

The chamber may have a closed top and bottom.

The sieve structure may have an opening at the top to relieve pressure.

The pump may be a water pump arranged to drain the separator.

The pump may be arranged to recirculate the filtered fluid to the conduit of the filter pressure regeneration apparatus and/or drain the separator.

A second pump may be arranged to recirculate the filtered fluid to the conduit of the filter pressure regeneration apparatus.

The separator further may comprise an air pump located between the pump and the filter pressure regeneration apparatus to introduce air into the conduit and to drain the separator.

A bypass conduit may be provided between the inlet and the outlet to provide an alternative route for fluid in the event that the flow of fluid is impeded. The bypass system may include an electronically operated valve.

A diverter valve may be provided to recirculate the filtered fluid to the conduit of the filter pressure regeneration apparatus and/or drain the separator.

The nozzle assembly may comprise a nozzle arranged to direct a stream of fluid towards a rotatable plate, wherein the plate is arranged to rotate under the force of the stream of fluid and to project the fluid outwards towards the sieve structure.

In an embodiment, a method of operating a separator of the type described above is provided comprising the steps of; filtering an fluid through a sieve structure, detecting at least one state of the separator and performing an operation in dependence on the detected state of the separator.

The state of the separator may include the presence or level of fluid in the separator.

The state of the separator may include the pressure differential between the filtered side and the unfiltered side of the sieve structure.

The operation may include operating a drain pump.

The operation may include operating a pressure regeneration apparatus that is arranged to spray the filtered side of the sieve structure with wash fluid to dislodge debris from the unfiltered side of the sieve structure.

The operation may include operating a recirculation pump to recirculate a portion of the filtered fluid to the pressure regeneration apparatus.

The operation may include operating a bypass system that includes an electronic valve.

The operation may include operating a diverter valve to recirculate filtered fluid to the pressure regeneration apparatus or direct water to drain.

### BRIEF DESCRIPTION OF THE DRAWINGS

FIG. 1 shows a typical domestic washing machine.

FIG. 2 shows a conventional separator.

FIG. 3 is a graph showing the efficacy of different types of filter assembly.

FIG. 4a shows a cross section of an embodiment having a control system for managing a pressure consumption regeneration apparatus of a separator.

FIG. 4b shows a cross section of an embodiment having a control system for managing another pressure consumption regeneration apparatus of a separator.

FIG. 4c shows a cross section of an embodiment having a control system for managing another pressure consumption regeneration apparatus of a separator.

FIG. 5a shows an embodiment having a cylindrical sieve structure and an array of fixed cleaning nozzles and a management system including a float switch.

FIG. 5b shows another view of the embodiment of 5a.

FIG. 5c shows an embodiment with a recirculation system.

FIG. 5d shows an embodiment with a drain system.

FIG. 6a shows a perspective view of an embodiment of a separator.

FIG. 6b shows a cross sectional view of an embodiment of a separator.

FIG. 6c shows a cross sectional view of an embodiment of a separator having a reservoir and drain pump.

FIG. 6d shows a cross sectional view of an embodiment of a separator shown in FIG. 6c.

FIG. 7 shows a cross sectional view of an embodiment of a separator having a combined drainage and recirculation pump.

FIG. 8 shows an alternative arrangement of pump and conduits.

FIG. 9a shows a cross sectional view of an embodiment of a separator having separate recirculation and drain pumps for recirculating filtered effluent as wash fluid and for draining the separator.

FIG. 9b shows a cross sectional view of an embodiment of a separator having a water pump for recirculation and an air pump for draining the separator.

FIG. 9c shows an alternative embodiment using a single pump which can alternate between supplying wash water and draining the filter by a use of a valve or valves.

FIG. 9d shows an alternative embodiment of a single pump in which the pump is pumping water to both the regeneration and the drain at the same time.

FIG. 10 shows an embodiment having a bypass system.

FIG. 10b is a perspective view of a filter assembly having a nozzle assembly with a rotatable plate.

FIG. 11a is a perspective view of an embodiment of a separator unit.

FIG. 11b is a perspective view of the embodiment of FIG. 11a with the jug removed.

FIG. 12a is a section view of the embodiment of FIG. 11a.

FIG. 12b is a perspective view of the pump and ducting assembly of the embodiment of FIG. 11a.

FIG. 13 is a perspective view of a part of a filter assembly of the embodiment of FIG. 11a.

FIG. 14 is a perspective view of a nozzle assembly of the embodiment of FIG. 11a.

FIG. 15 is a top view of the jug of FIG. 11a with a cap removed.

FIG. 16 is a view of a printed circuit board in place in a component of the embodiment of FIG. 11a.

FIG. 17a shows a washing machine equipped internally with an embodiment of the separator

FIG. 17b shows a washing machine retro-fitted externally with an embodiment of the separator.

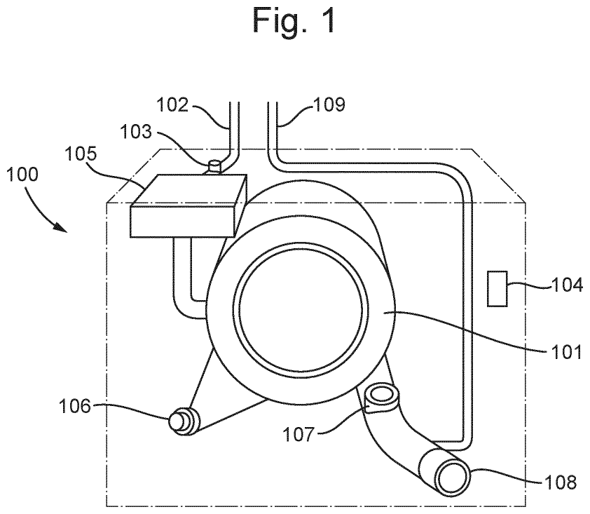

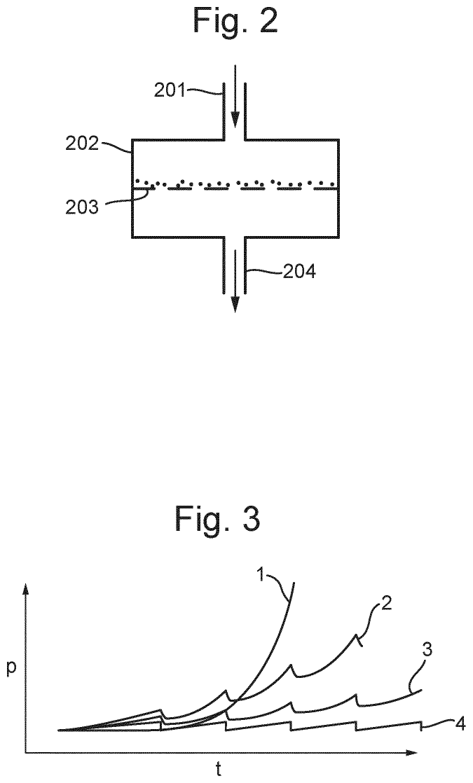

### DETAILED DESCRIPTION OF THE PREFERRED EMBODIMENT

While the description that follows focuses on washing machines for clothes, it is to be understood that the teachings herein are not limited to use in washing machines as they are equally suited to other processing appliances, such as but not limited to driers, such as wash-dryer combination machines, tumble driers, dyeing machines, cutting machines, recycling machines, dry cleaning machines and so on. The washing machines or other processing appliances could be domestic or commercial. The teachings herein could also be used in other industries in which microparticles may be generated as a result of processing of items. References to washing machines herein are therefore to be understood as comprising any similar appliance of the types contemplated herein.

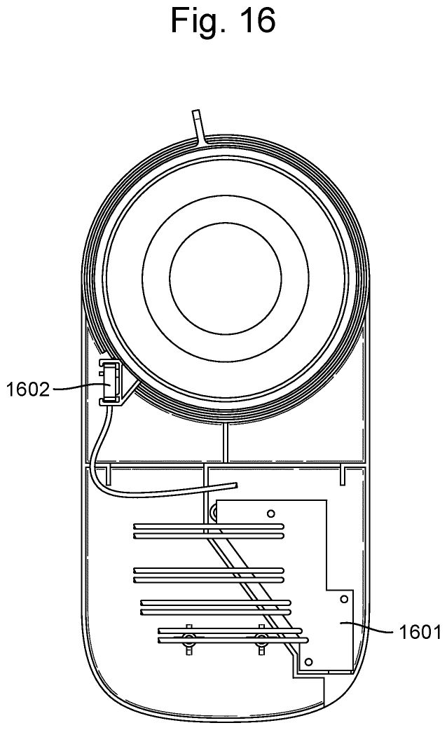

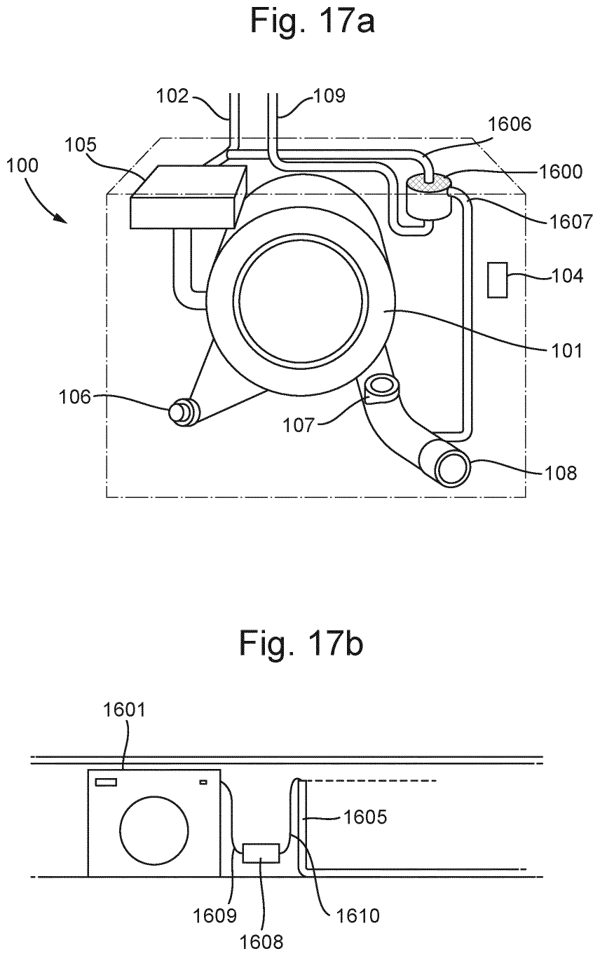

The separator described herein may be installed within the appliance itself during manufacture as shown in FIG. 16a, or retro-fitted externally to a washing machine or other appliance, as shown in FIG. 16b.

The separator system 1600 described above may be installed within a washing machine, as shown in FIG. 16a. The waste from the washing machine drum connects to the inlet 2807 of the separator 1600 and the outlet of the separator connects to the waste outlet 1609 or feed back into the drum. A supply of fresh water 1606 for the regeneration apparatus is shown but if the recirculation system is used then this supply is unnecessary. A separator system 1608 may be located outside a washing machine, connected to the waste water outlet of the washing machine, as shown in FIG. 16b. The inlet 1609 supplies effluent into the separator 2808 and the outlet 1610 feeds into the soil pipe 1605 or back into the drum. The embodiment shown is fitted with a drain pump to enable installation below the dotted water line in the figure, i.e. the top of the soil pipe. The embodiment shown also has a recirculation system therefore a separate supply of fresh water is not needed. The device may be connected to an electrical power supply (not shown) to operate the pump or pumps.

It will further be appreciated that the teachings herein are suited to any application, which requires the removal of microplastics, including microfibers, from any effluent, including wastewater, within which such materials may be entrained.

It should be noted that wastewater from a washing machine, and other applications, contain a wide variety of compounds including microplastics. Although the filter is specifically suited to the capture of microplastic, due to the environment in which it operates, this system is also robust against the harsh and varied compounds the filter comes into contact with and is also suited to filtering out any solid material entrained in an effluent.

Effluent is understood to include wastewater from the sources mentioned above. It can also include the wastewater from Wastewater Treatment Plants. Effluent includes entrained dirt, detergent and micropollutants including microplastics, which include microfibers.

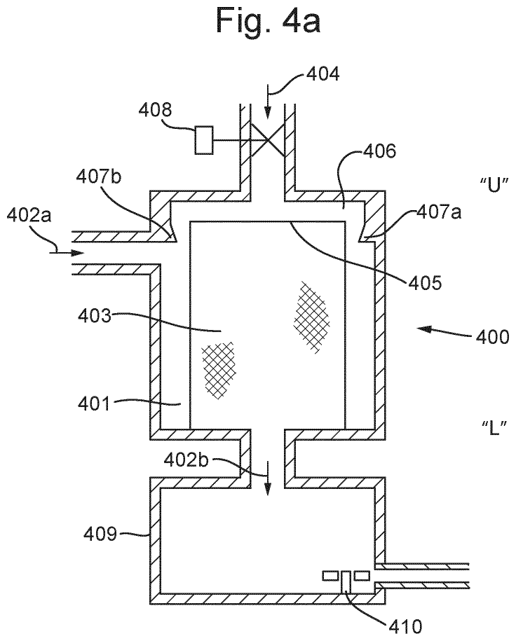

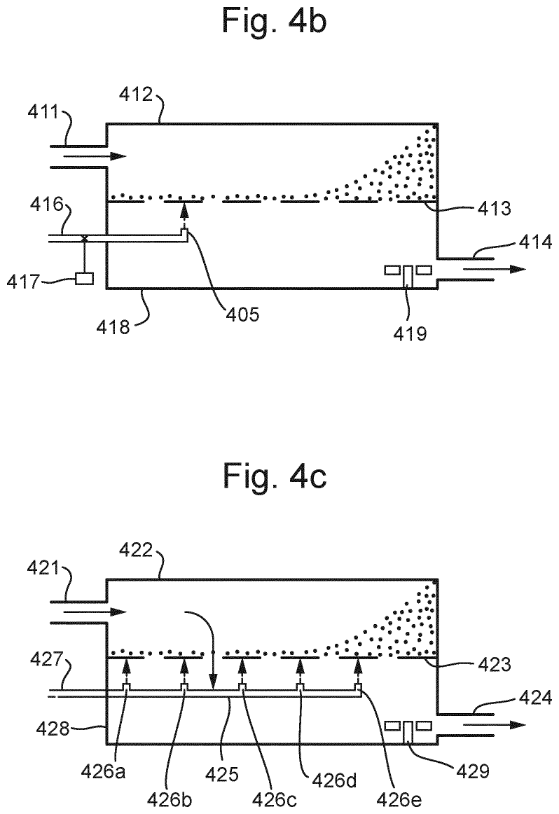

FIG. 4a shows an embodiment of the invention having a pressure consumption regeneration system that is activated when the efficacy of the filter falls below an acceptable level. Filter efficacy is its effectiveness at removing debris of a given size range while maintaining an acceptable flow rate and is closely related to the filter's pressure consumption. As a filter becomes blinded over by debris, its pressure consumption increases, and its efficacy decreases. The embodiment of the invention described below regenerates the pressure consumption of a filter back to the level, or close to the level, of when it was new. A separator 400 for separating microfibers from washing machine effluent is provided having a cylindrical chamber 401 with an effluent inlet 402a at an upper end “U” and an outlet 402b at a lower end “L”. A cylindrical mesh structure 403 with a pore size of 80 μm, although a mesh with pore sizes in the range 5-150 μm may be used, is located within the chamber 401 presenting a permeable barrier between the inlet and the outlet. The mesh structure 403 has a deflector 405 at its upper end. The deflector is a disk for deflecting wash water and distributing it outwards to its edges. A wash water inlet 404 is located at the upper end of the chamber 400. There is a clearance 406 between the deflector 405 of the mesh structure 403 and the top of the chamber, which provides a path for wash water to enter the chamber. Wash fluid guides 407a,b are located around the edge of the upper part of the chamber to direct the wash water onto the mesh surface. The guides are arranged to spray the surface of the mesh with mains pressure clean water. Mains pressure water is supplied under the control of a solenoid-operated valve 408. The guides are inwardly projecting circular flanges with a tapered funnel shape. Filtered effluent leaves the chamber 401 and enters a reservoir 409 that includes a fluid detector, such as a float switch 410 for detecting the presence of fluid in the reservoir. The fluid detector controls the solenoid-operated valve such that when fluid is detected in the reservoir, the valve is opened so that debris is washed from the sieve structure. Alternatively a pressure sensor may be used, that can detect a pressure differential between either side of the sieve structure. When the pressure rises above a predetermined threshold, the solenoid-operated valve is opened so that debris is washed from the sieve structure.

FIG. 4b shows another embodiment of a separator that regenerates the pressure consumption of a filter when required. The separator comprises an effluent inlet 411 feeding a channel bounded by a filter housing 412 and a sieve structure 413. The filtered effluent exits from the separator via an outlet 414. A cleaning nozzle 415 is provided that is arranged to direct a cleaning jet of wash fluid towards the filtered side of the sieve structure 413. The cleaning nozzle 415 is connected by conduit 416 to a supply of wash fluid, such as mains water. A solenoid-operated valve 417 controls the supply of wash fluid. The valve 417 is periodically activated to dislodge filtered material from the unfiltered side of the sieve structure, which regenerates the pressure consumption and thus allows more effluent to be filtered out. As the waste material is dislodged, the flow of effluent carries it further away from the inlet towards the far end of the channel. A reservoir 418 in the lower part of the housing 412 is provided. A fluid sensor 419 in the reservoir detects when filtered effluent is present and is arranged to control the valve 417 when fluid is present. The terms fluid sensor and fluid detector are used interchangeably herein.

FIG. 4c shows an embodiment of a separator with an array of cleaning nozzles. The separator comprises an effluent inlet 421 feeding a channel bounded by a filter housing 422 and a sieve structure 423. The filtered effluent exits from the separator via an outlet 424. The nozzle assembly 425 comprises a plurality of cleaning jets 426a, b, c, d, e fed with wash fluid by conduit 427. The wash fluid may be mains water controlled by a solenoid valve. The cleaning jets are periodically activated to dislodge filtered material from the unfiltered side of the sieve structure, which allows more effluent to be filtered out and thus regenerate the pressure consumption. As the waste material is dislodged, the flow of effluent carries it further away from the inlet towards the far end of the channel. A reservoir 428 and float switch 429 at the outlet may control activation of the cleaning jets or it may have a branch duct with a sensor to detect when effluent is backing up.

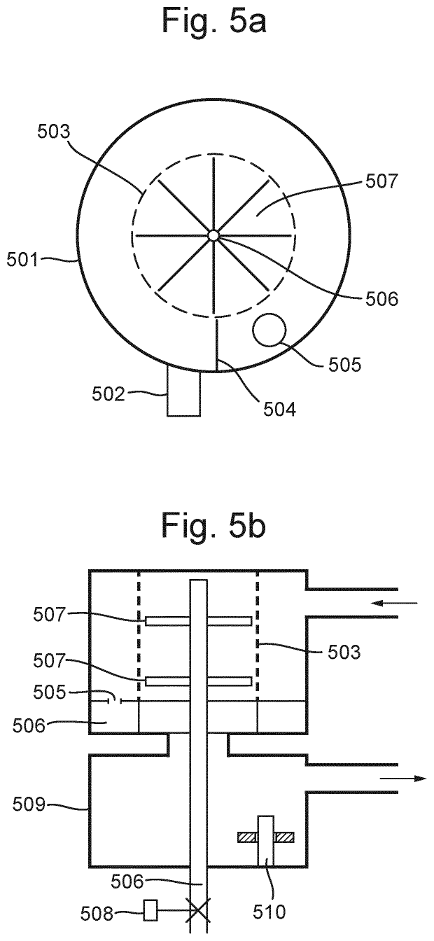

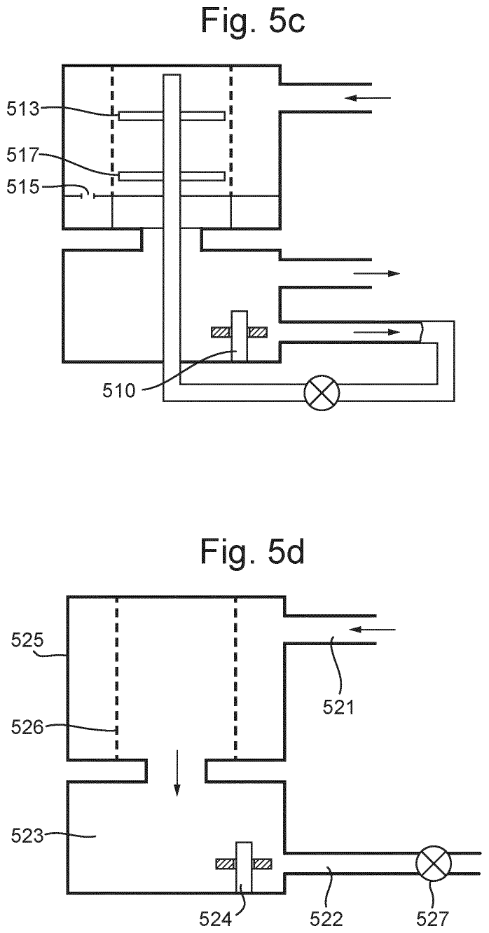

FIG. 5a shows an embodiment of a separator that regenerates the pressure consumption of a filter back to the level, or close to the level, of when it was new. A cylindrical chamber 501 is provided having an inlet 502 and a central cylindrical sieve structure 503. A wall 504 is provided to one side of the inlet that serves as a baffle to allow effluent to only flow one way when it enters the chamber and to allow filtered debris to collect in a specified location in the chamber. The inner wall of the chamber 501, the outer wall of the sieve structure 503 and wall 504, define a channel through which unfiltered effluent flows around to the other side of the wall 504 where it can accumulate. An aperture 505 is provided through which the filtered material can pass and be trapped.

FIG. 5b shows a cross section of the separator shown in FIG. 5a. A filter pressure regeneration system is provided comprising a wash fluid conduit 506 that supplies wash fluid to an array of cleaning nozzles 507 that project radially outwards from the conduit 506 and are arranged to direct wash fluid perpendicularly at the filtered side of the sieve structure 503 to dislodge material that accumulates against the unfiltered side of the sieve structure. As material is dislodged it is swept by the flow of effluent towards the end of the channel, through the aperture 505 and into the trap 506. The jets of wash fluid can be operated continuously or periodically. The wash fluid is pressurised and forced through the cleaning nozzles so that the jets of wash fluid emanating from the cleaning nozzles have enough power to dislodge material, against the flow of the fluid component of the effluent passing through the sieve structure. The wash fluid could be clean mains water and the pressure provided by mains water pressure. Mains pressure water is supplied under the control of a solenoid-operated valve 508. A pump could also be used to pump clean water or another fluid from another source. A reservoir 509 in the lower part of the chamber 501 is provided. A fluid senor 510 in the reservoir detects when filtered effluent is present and is arranged to control the valve 508 when fluid is present.

FIG. 5c shows another embodiment where a branch is provided to recirculate filtered effluent back to the cleaning nozzles. When fluid is detected in the reservoir by the fluid sensor 510 a pump can be activated to recirculate the filtered effluent and clean the mesh from the unfiltered side to regenerate the pressure of the separator.

FIG. 5d shows another embodiment that can drain the separator. The separator has an inlet 521 to a chamber 525 having a filter structure 526. A reservoir 523 is provided having a fluid sensor such as a float switch 524 to determine when fluid is in the system. Alternatively, a capacitive sensor may be provided at the inlet, at the outlet or in or near the reservoir, for detecting the presence of fluid. The reservoir has an outlet 522 that is connected to a pump 527. When the presence of fluid is detected in the system, the pump can be activated to drain the separator. This embodiment allows a separator to be fitted in any location, including below the waterline of a washing machine.

The fluid sensor could be arranged so that it is activated when a particular level of fluid is detected and then activates either the drainage of the separator or pressure regeneration apparatus or both. Alternatively, the fluid sensor could be graduated so that it determines the level of fluid in the reservoir and the drainage is activated at a given level and the regeneration is activated at a different fluid level.

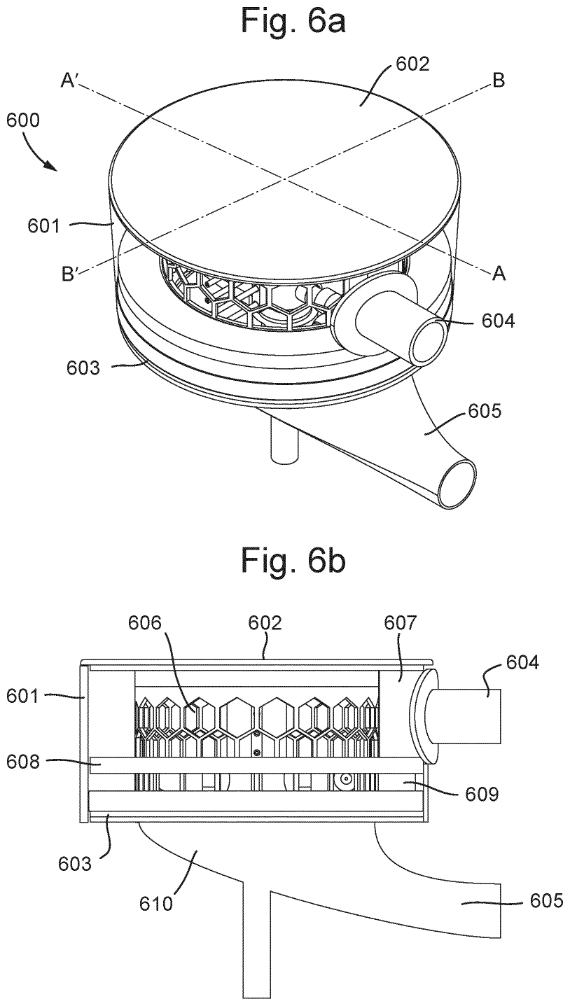

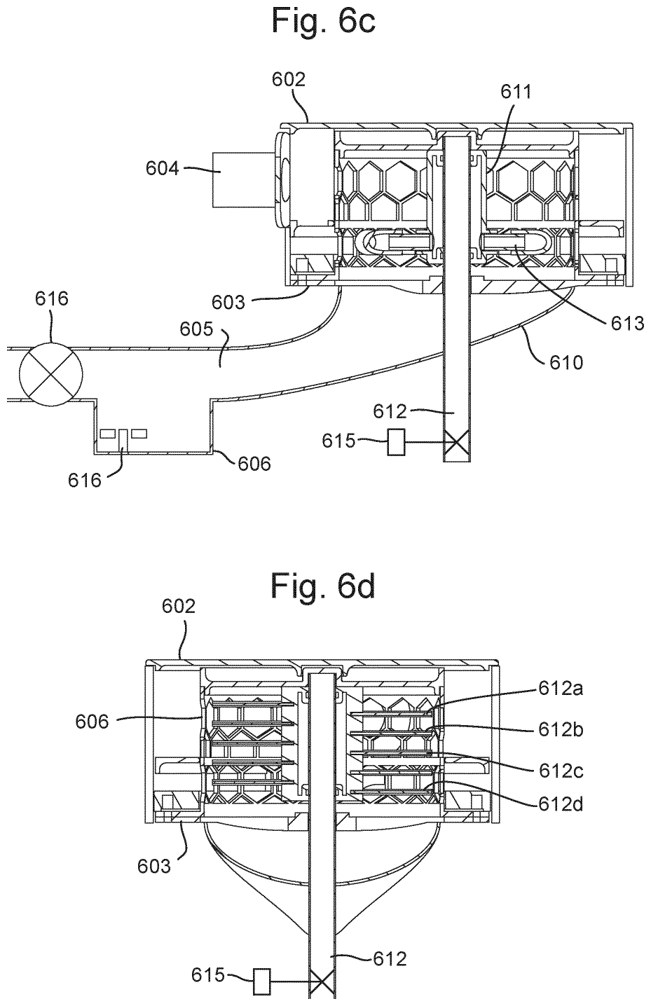

FIG. 6a shows a separator unit that includes a filter pressure regeneration system. The separator unit 600 comprises an outer cylindrical wall 601. In this embodiment the outer wall is transparent so that a user can see when the separator is operational and can also see the accumulated filtered waste. The separator unit 600 has a circular cap 602 and base 603. An inlet 604 is provided in the wall 601. An outlet 605 is provided in the base 603. A reservoir 606 is provided below the separator. A cylindrical sieve structure 607 is provided coaxially with the outer wall 801. The sieve structure extends between the cap 602 and the base 603 and provides a seal beyond which unfiltered effluent cannot pass. The sieve structure comprises an open support scaffold to which is fixed a mesh of aperture 50 micrometers. Mesh sizes in the range 5-150 micrometers are also suitable. The mesh separates the solid material from the liquid component of the effluent. An interior dividing wall 607 creates a channel for the effluent to flow around the sieve structure, starting at the inlet 604. The chamber is divided horizontally into two parts by a partition 608. The partition 608 has an opening on the other side of the interior dividing wall 607. The combination of the opening and the lower part of the chamber beneath the partition 608 provide a trap 609 within which waste material can accumulate.

The separator unit is around 15 cm in diameter. However, it will be appreciated that larger or smaller diameters could be selected depending on the application. The size of the unit is selected on the flow rate of effluent to be filtered. A separator diameter of 15 cm is sufficient to process the effluent from a domestic washing machine flowing at a rate of 10 litres per minute.

The open area of the mesh that enables the passage of water at a given flowrate can be adjusted by changing either the surface area of the mesh or the mesh aperture. The mesh aperture effects the efficiency, so a smaller mesh aperture is generally preferable to provide greater efficiency. The mesh surface area is a function of the height and diameter, therefore a given area can be matched by increasing the height if the diameter is reduced, and visa versa. All variables can be adjusted to meet product packaging and efficiency specification requirements.

The separator has a filter pressure regeneration system comprising a nozzle assembly that has a central hub 611 supporting one or more cleaning nozzles 612a, b etc that extend radially from the hub 611. The hub includes a conduit to feed pressurised wash fluid to the cleaning nozzles. The cleaning nozzles are arranged as a stack of four directly above each other and a matching stack directly opposite on the hub. This arrangement ensures that the entire width of the sieve structure is cleaned in each sweep of the nozzle assembly. The central conduit 612 feeds the cleaning nozzles with pressurised wash fluid, in this embodiment the wash fluid is mains water controlled by a solenoid valve 615. Effluent enters the separator via inlet 603 and passes around the channel formed by the outer wall of the chamber and the sieve structure 604 around to the wall 605 where filtered material accumulates in the trap 606. The cleaning nozzles 612a, b are aligned perpendicularly to the sieve structure 607. A nozzle assembly rotator that is fixed to the cleaning nozzles rotates the cleaning nozzles. The nozzle assembly rotator 613 comprises a central hub 614 that acts as a conduit for propulsion fluid. The wash fluid conduit and rotation unit hub are connected so that the wash fluid propels the nozzle assembly. The rotator 613 has radially extending arms that terminate in propulsion nozzles that are directed perpendicularly to the arms. Fluid exiting the propulsion nozzles is directed tangentially to the axis of the hub, causing the nozzle assembly to rotate.

FIG. 6b shows an embodiment with a reservoir 606. A fluid detector such as a float switch 616 in the reservoir 606 detects when filtered effluent is present and is arranged to control the valve 615 when fluid is present. The reservoir 606 also has an outlet that is connected to a pump 616. The pump is arranged to operate when fluid is detected in the reservoir and this allows the separator to be located below the water line.

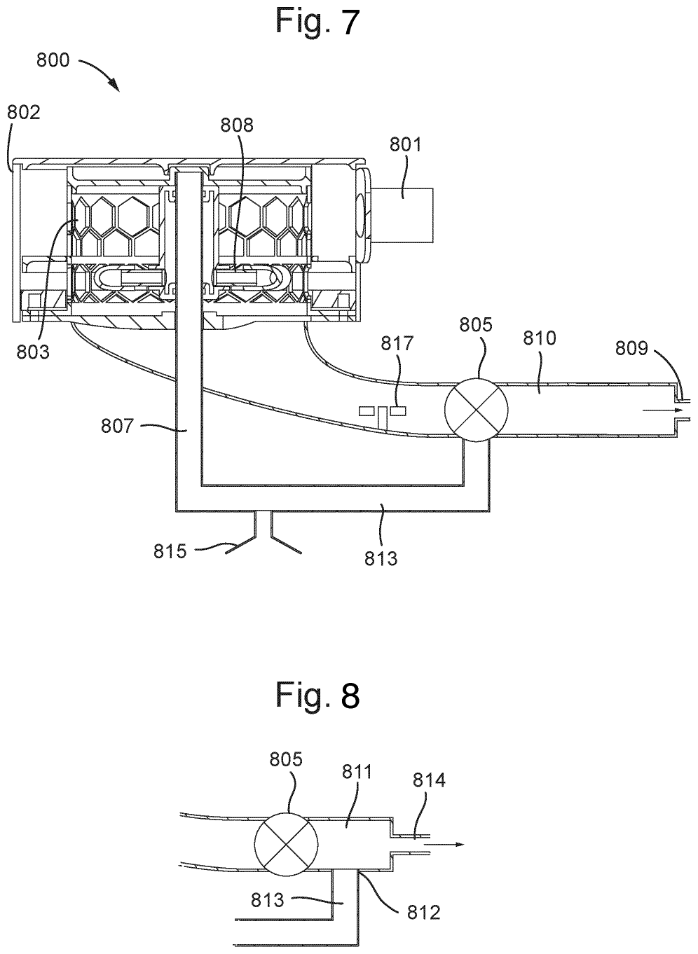

An alternative arrangement is shown in FIG. 7, where a pump 805 can pump fluid out of the separator and also a portion back to the nozzle assembly. Alternatively, the pump 806 may have a single outlet as shown in FIG. 8b and a junction 812 that diverts some filtered effluent to conduit 813 to be re-circulated into the pressure regeneration system and the rest to the soil pipe. A restriction 809/814 is provided to determine the proportion of filtered effluent that is re-circulated. An air inlet 815 in the conduit 813 may be provided that allows air into the pressure regeneration system to enhance the cleaning effect of the jet of cleaning fluid against the filtered side of the sieve structure. A fluid sensor such as a float switch 817 is provided beneath the separator unit. The fluid sensor detects when fluid is present in the reservoir. The fluid sensor is arranged to control the pump to wash the sieve structure to regenerate the filter pressure. FIG. 8 shows an arrangement with a junction 1812 that diverts some filtered effluent to conduit 1813 to be re-circulated into the pressure regeneration system and the rest to the soil pipe. A restriction 1814 is provided to determine the proportion of filtered effluent that is re-circulated.

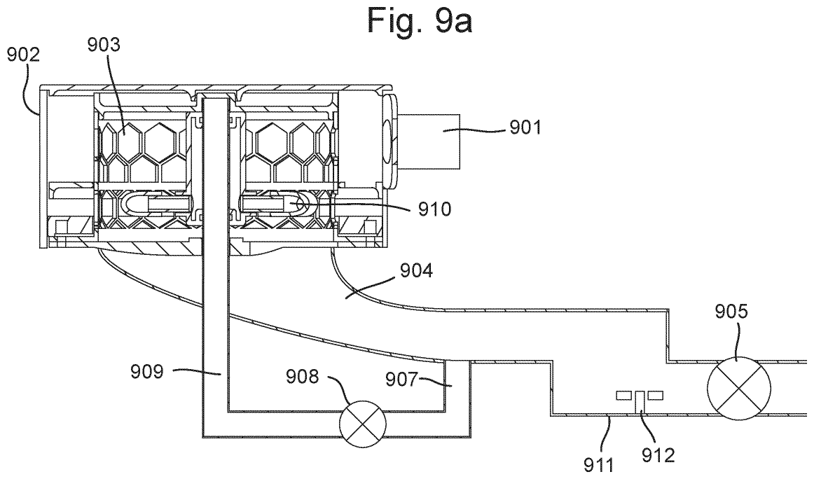

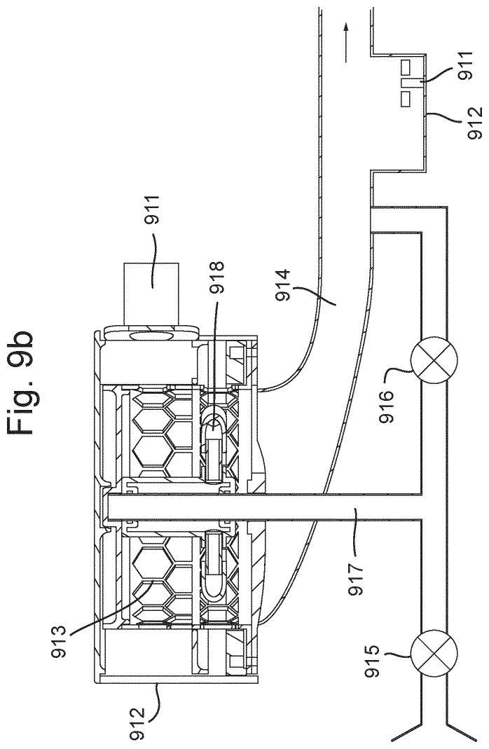

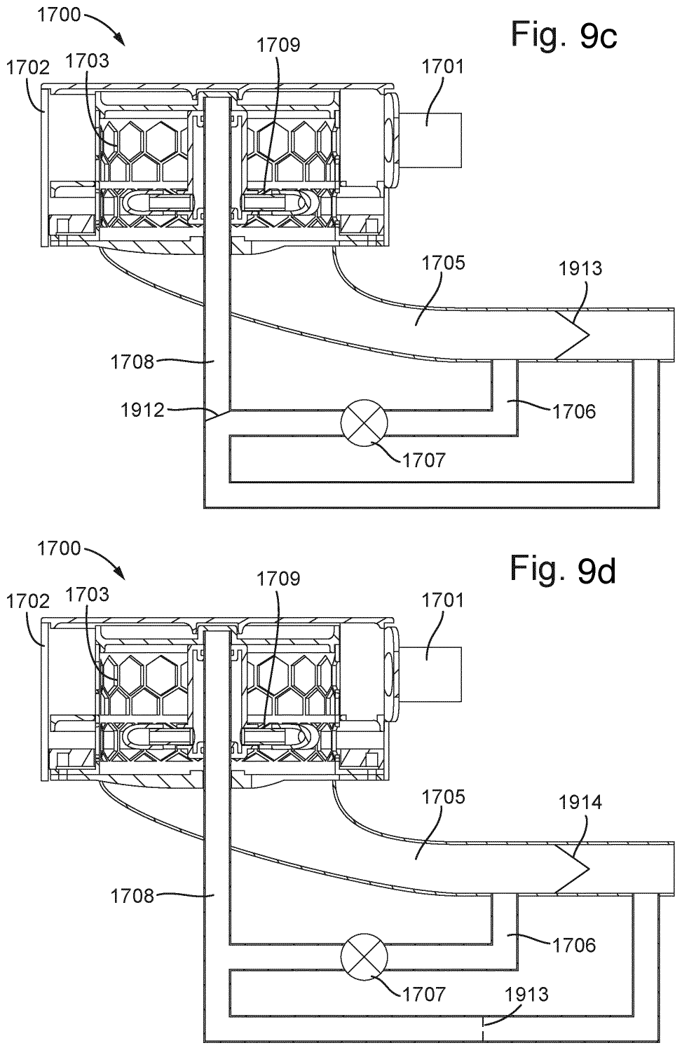

It may be advantageous to be able to control the drainage of a separator unit and the pressure regeneration separately. FIG. 9a shows an embodiment that includes two pumps; a drainage pump 905 and a recirculation pump 908. The separator unit has an inlet 901 into a housing 902 that supports a sieve structure 903 that separates the inlet 901 from the outlet 904. The outlet 904 has a conduit that leads to the drainage pump 905. Also on the filtered side of the sieve structure is a wash fluid conduit 907 that leads to a wash fluid pump 908 and on to a further wash fluid conduit 909 that feeds the cleaning nozzle assembly 910. The drainage pump 905 may be a positive displacement pump or a centrifugal pump that operates at around 0.1 Bar 15 litres per minute, but could be in the range up to 1 bar and 30 litres per minute. The recirculation pump 1408 operates at around 0.3 Bar and 8 litres per minute, but could be in the range up to 5 bar and 15 litres per minute. The primary advantage of the setup is that the drainage pump can be sized to drain the filter only and does not need to run during the washing machine drain cycle. This reduces power consumption, size and cost of drainage pump. A one-way valve (not shown) may be used to prevent the drained water recirculating to the pump inlet.

A reservoir 911 with a fluid sensor such as a float switch 912 is provided beneath the separator unit. The fluid sensor detects when fluid is present in the reservoir. It can be arranged to determine the level of fluid in the reservoir. The fluid sensor is arranged to control the recirculation pump 908 to wash the sieve structure to regenerate the filter pressure and/or the drainage pump 905. Alternatively a sensor can be provided at the inlet to detect when fluid has entered the system or if effluent is backing up and this can be used to activate the pump to regenerate the filter pressure. A pressure differential sensor could be provided to detect when there is a difference in pressure between the inlet and the outlet and pressure regeneration is required. The drainage pump could be operated when fluid is detected in the reservoir or when a particular level of fluid is detected or when any fluid is detected anywhere in the system.

FIG. 9b shows an alternative embodiment of a separator unit where an air pump is used to assist with regeneration and drainage. An inlet 911 is provided into a housing 912 that supports a sieve structure 913 that separates the inlet 911 from an outlet 914. A conduit leads to a pump 916 that pumps filtered effluent into a further conduit 917 that feeds wash fluid to a cleaning nozzle assembly 918. An air pump 919 is connected into the further conduit 917 to pump air into the wash fluid system. Air enhances the cleaning effect of the wash fluid jet emanating from the cleaning nozzle 918. The air pump can also be operated to push any remaining fluid in the pipe connected to the outlet 914 up to the waterline, which enables this embodiment to be mounted below the waterline. Air can also dry the filtered microplastic for ease of handling when the unit is emptied. A one-way valve would need to be provided at the inlet (not shown) to prevent fluid from being pushed back into the washing machine. A reservoir 911 with a fluid detector such as a float switch 912 is provided beneath the separator unit. The float switch detects when fluid is present in the reservoir. Alternatively, a fluid detector such as a capacitative sensor could be provided at the inlet, the outlet or in proximity to the reservoir to detect when fluid is present in the system, i.e. that the washing machine is draining. The float switch is arranged to control the pumps 906 and 907 to wash the sieve structure to regenerate the filter pressure. Alternatively a branch duct with a sensor can be provided at the inlet to detect when effluent is backing up and this can be used to activate the pump to regenerate the filter pressure.

FIG. 9c shows an alternative embodiment that has a single pump 1707, which can supply wash water or drain the filter by a use of a diverter valve 1912. A one-way valve 1913 is required to prevent the drained water recirculating to the pump inlet.

FIG. 9d shows an alternative embodiment of a single pump 1707 in which the pump can pump water to both the regeneration system 1708 and the drain at the same time. The drain line has a constriction 1913 to force the majority of the water through the regeneration route. A one-way valve 1914 is required to prevent the drained water recirculating to the pump inlet.

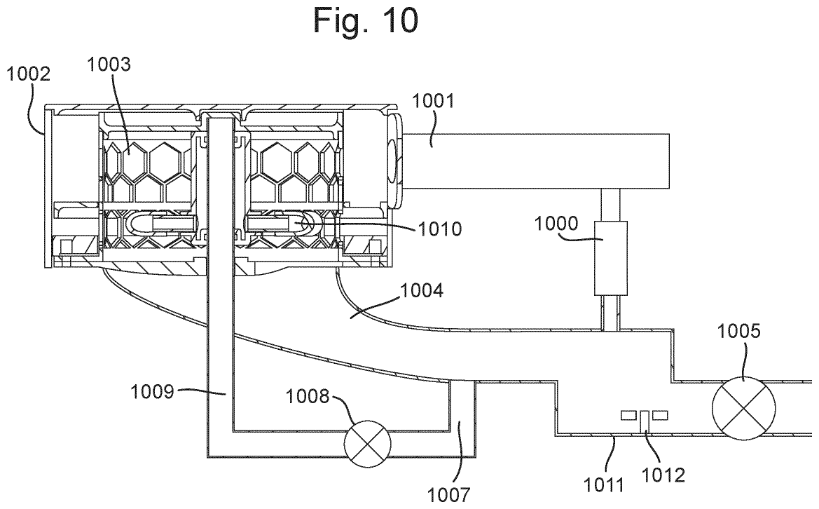

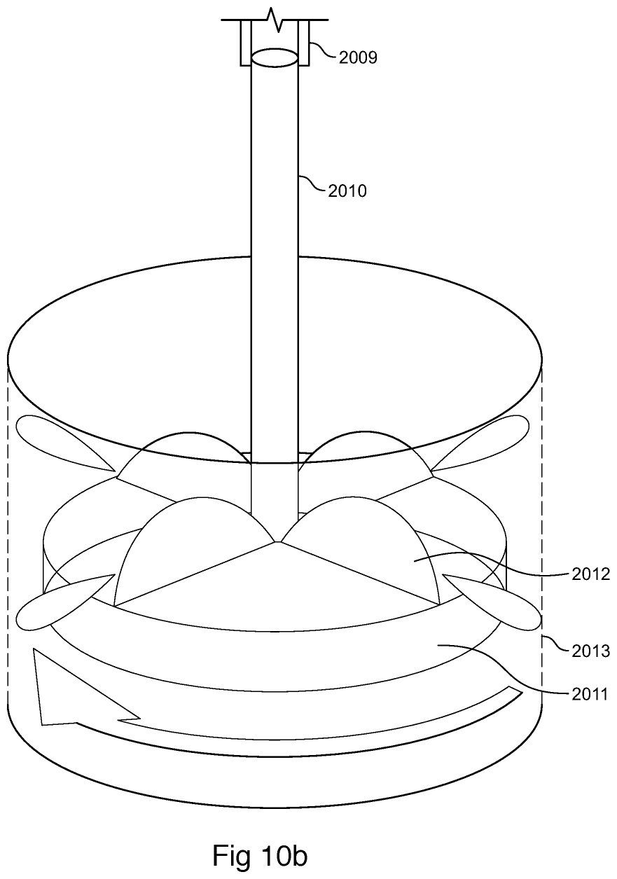

A bypass system 1000 may be provided to connect the inlet 1001 to the outlet 1002, as shown in FIG. 10. It ensures that if the separator gets blocked or the regeneration system fails for some reason, the entire wash load of effluent will not back up and cause a flood but be diverted to the waste outlet.

FIG. 10b shows an alternative nozzle assembly having a nozzle 2005 arranged to direct a stream of fluid 2010 towards a rotatable plate 2011. The plate has features 2012 that are arranged to deflect the stream of fluid outwards towards the sieve structure 2013. The features 2012 are also arranged to cause the plate to rotate, so that the projected fluid sweeps across the surface of the outlet side of the sieve structure and thus dislodges debris on the other side.

An embodiment of a separator unit has a bypass feature for allowing effluent to go around the filter if it becomes clogged. The separator unit has an effluent inlet, a housing supporting a sieve structure and an outlet. A bypass conduit links the inlet to the outlet. A pressure-activated valve is located in the conduit. The pressure-activated valve opens when the pressure at the inlet exceeds a certain pre-set value. Therefore, if effluent backs up at the inlet because the filter is clogged, the valve will open and let effluent through to the outlet where it can safely discharge to a waste pipe. Alternatively, the valve may be of a type that can be electronically controlled. A pressure sensor that detects a pressure differential between the two sides of the sieve structure can control the valve, so that if the pressure differential reaches a predetermined level, the valve is operated and the bypass activated.

The separator system 1600 described above may be installed within a washing machine, as shown in FIG. 16a. The waste from the washing machine drum connects to the inlet 1607 of the separator 1600 and the outlet of the separator connects to the waste outlet 109. A supply of fresh water 1606 for the regeneration apparatus is shown but if the recirculation system is used then this supply is unnecessary. A separator system 1608 may be located outside a washing machine, connected to the waste water outlet of the washing machine, as shown in FIG. 16b. The inlet 1609 supplies effluent into the separator 1608 and the outlet 1610 feeds into the soil pipe 1605. The embodiment shown is fitted with a drain pump to enable installation below the dotted water line in the figure, i.e. the top of the soil pipe. The embodiment shown also has a recirculation system therefore a separate supply of fresh water is not needed. The device may be connected to an electrical power supply (not shown) to operate the pump or pumps. A more detailed description of a stand-alone separator is provided below:

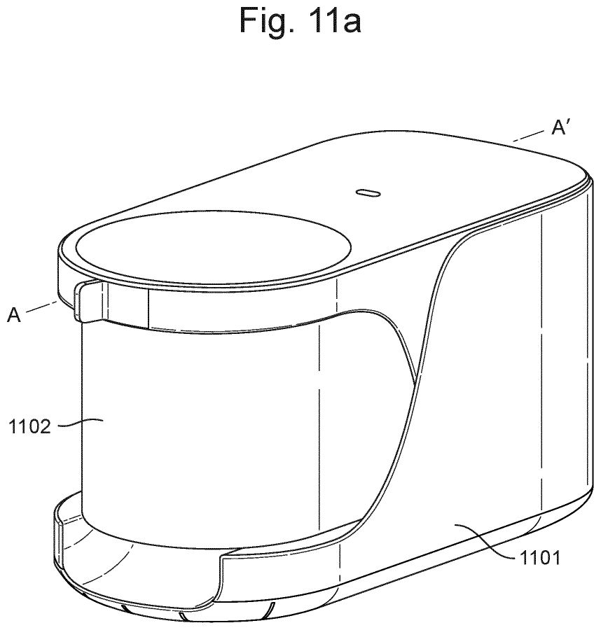

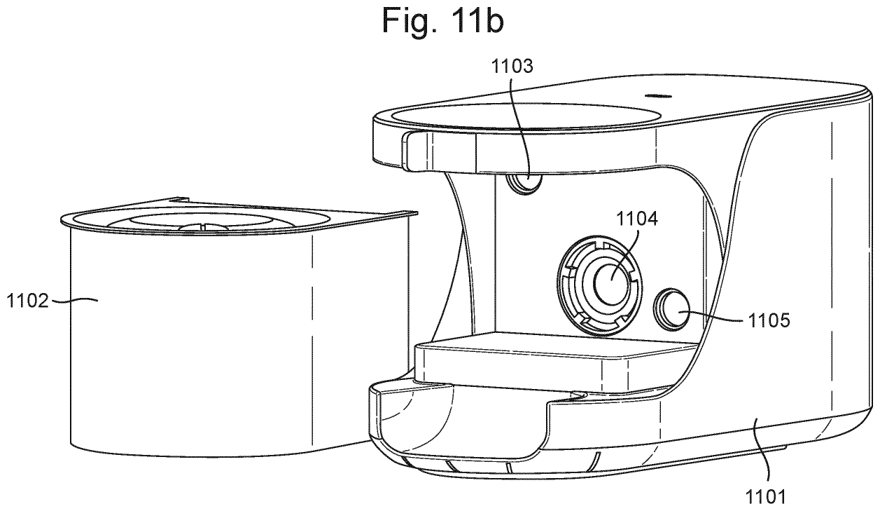

A separator unit for locating externally to a textile processing apparatus such as a domestic washing machine is shown in FIG. 11a. The unit 1100 comprises a body 1101 that has a waste water inlet and outlet (not shown) and a removable jug 1102. The jug includes a filter that can collect filtered microfibers. Removal of the jug allows the filtered microfibers to be emptied. FIG. 11b shows the unit 1100 with the jug removed and separated from the unit. The jug has conduits for effluent inlet, effluent outlet and a pressure consumption regeneration fluid feed. The pressure consumption regeneration fluid is recirculated filtered effluent. The conduits terminate in stubs and the main body of the unit has openings to receive these conduit stubs; effluent inlet 1103, filtered effluent outlet 1104 and recirculated filtered effluent 1105. Each opening has a watertight seal that ensures no fluid leaks from the joints between the stubs and the openings when the jug is in place.

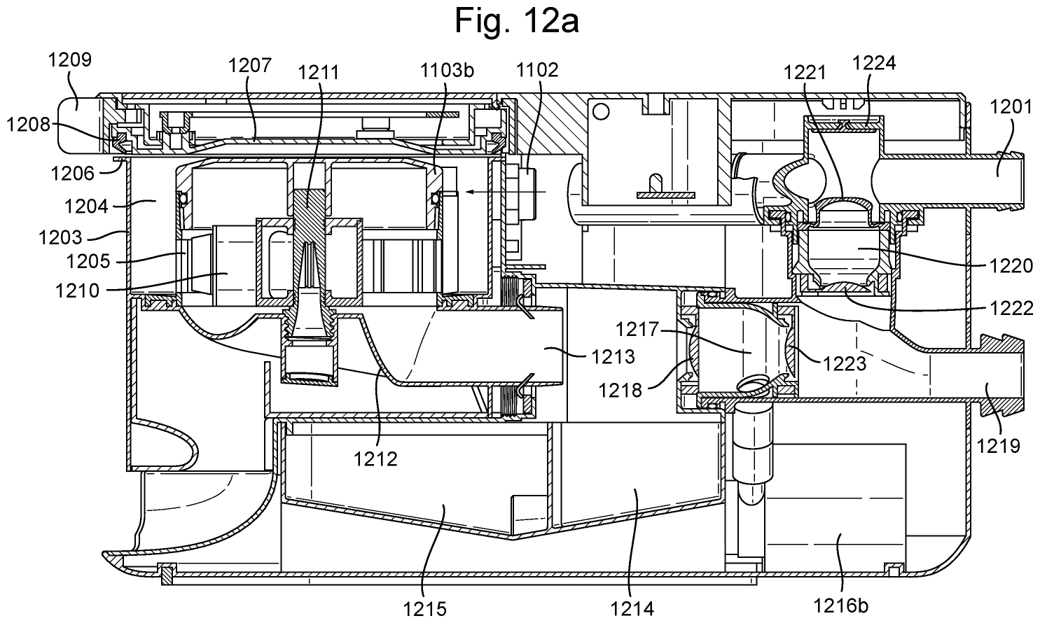

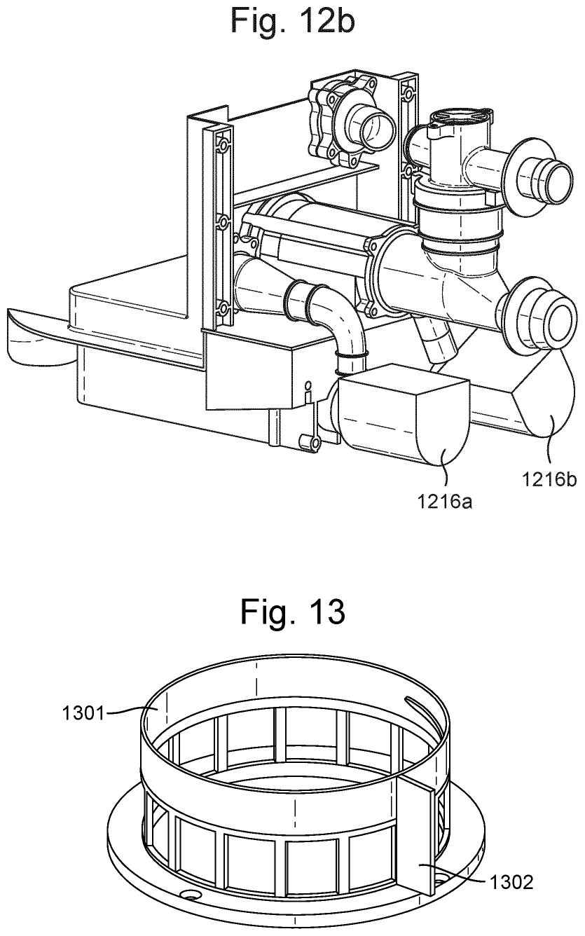

FIG. 12a shows a cross section of the unit 1100 taken along line A-A′ in FIG. 11a. The unit has a waste water inlet 1201 that can be connected to the outlet of a washing machine. A conduit leads to the inlet stub 1202 of the jug 1203 where the waste-water, when the unit is in use, is directed tangentially into a cylindrical chamber 1204 of the jug 1203. Centrally located within the jug 1203 is a cylindrical filter assembly 1205, shown in more detail in FIG. 13. It is a plastic cage 1301 having a series of openings between a set of vertical ribs. A mesh (not shown) is overmoulded to the plastic cage. The mesh is flush on the outside of the ribs. A baffle 1302 is provided that forms a wall inside the chamber 1204 to one side of the jug inlet 1202 so that effluent progresses around the inside of the chamber in only one direction. Captured particles pass around the filter, collect at the baffle and build up at the far side of the filter away from the inlet. This limits recirculation of the captured particles. The mesh by the inlet is kept clear and clean from particles. Therefore, when wastewater enters the filter chamber it can pass through the mesh. The filter assembly has a cap 1203b to prevent unfiltered effluent overflowing into the outlet. This filter cap can also be removed to allow the user to gain access to the regeneration apparatus for maintenance. The cap is designed in the top of the filter assembly to ensure that no captured effluent can escape through this route during maintenance. The jug 1203 has an open top so that a user can access the interior to remove filtered microplastics. The jug 1203 has an outer rim with a flange 1206. When the jug 1203 is installed in the unit, a lid 1207 is lowered onto the jug. The lid includes a seal 1208 that engages with the flange 1206. A lever 1209 operates a mechanism to lower the lid onto the jug and provide a water-tight seal of the jug into the unit.

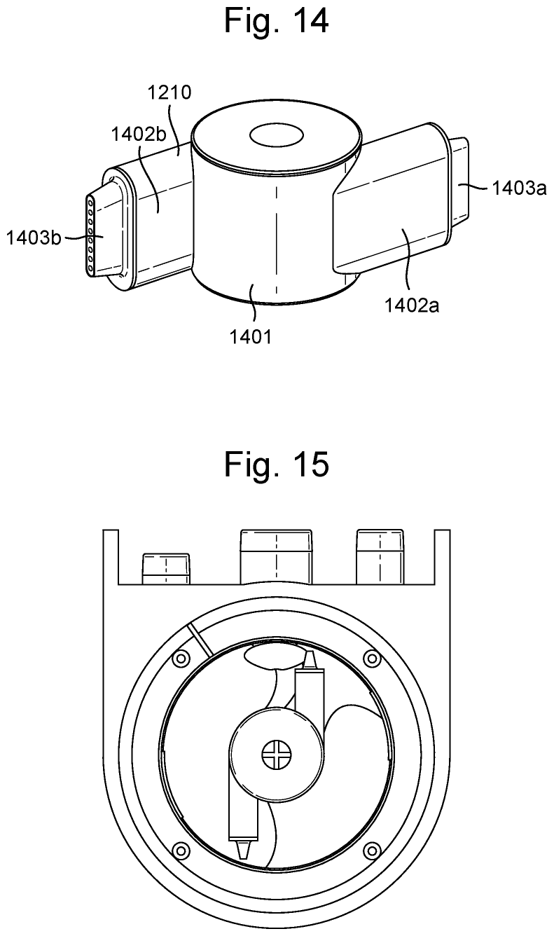

Located within the filter assembly of the jug is a pressure consumption regeneration apparatus comprising a rotatable nozzle assembly 1210 mounted on a hollow spigot 1211. The rotatable nozzle assembly is captive on the spigot by the filter assembly cap 1203b. The spigot is fed by a conduit that is routed through the unit to a recirculating pump 1216a, shown in FIG. 12b, that can provide wash fluid to the nozzle assembly. The nozzle assembly is shown in more detail in FIG. 14. Two hollow arms 1402a, 1402b are tangentially connected to a central hub 1401. The end of each arm has a vertical column of nozzles 1403a, 1403b that are arranged to extend over the height of the mesh. The nozzles may be flexible so that any limescale build up can be easily cracked off. The offset from central axis arrangement of the nozzle assembly means that when pressurised fluid is forced through the nozzles by the recirculation pump, it will cause the assembly to rotate at around 30-150 rpm. Rotation is arranged to be in the opposite direction to the flow of fluid around the chamber; in this way, the angle of impact of the jet of fluid emitted from the nozzles is with the flow of effluent, which allows debris that is dislodged to flow further around the mesh than if the angle was against the flow of effluent. FIG. 15 shows the nozzle assembly in place within the jug assembly. The spigot on which the regen apparatus is mounted operates as a plain bearing. It has a bleed path at the upper and lower section that allow an amount of wash fluid to exit. This is limited by a labyrinth seal of grooves. It is important to allow wash fluid to exit here as it ensures that any debris that may pass into this mechanical system can also be passed out and limit the risk of jamming. The grooves are toleranced to allow the largest particle that can fit through the mesh aperture in any orientation to pass through this bearing.

The jug 1203 is provided with a moulding 1212 that collects the filtered effluent that has passed through the mesh. This moulding channels effluent to the jug outlet 1213. The jug outlet feeds two reservoirs; a recirculation reservoir 1214 and a drainage reservoir 1215. The recirculation reservoir is connected to the recirculation pump 1216a. The drainage reservoir is connected to a drainage pump 1216b, shown in FIG. 12b. The outlet from the drainage pump feeds into a chamber 1217 that has a one-way valve 1218 to prevent filtered effluent from returning to the reservoirs 1214, 1215. Filtered effluent leaves the unit via outlet 1219.

Upon drainage from the filter unit the reservoirs are arranged to prioritise filling of the recirculation reservoir before the drainage reservoir. This ensures that there is always a supply of wash fluid for recirculation and it is not removed by the drainage pump.

The volume of the recirculation reservoir is designed to ensure a supply of wash fluid that can provide constant recirculation without fully emptying the reservoir. It might be advantageous in some scenarios to limit this and only provide enough wash fluid for a ‘burst’ as the reduction in this volume enables the product size to be reduced.

The volume of the drainage reservoir is designed to ensure any back flowing fluid from the outlet ducting and hose pipe can back fill into this chamber without overflowing. This ensures that the user can remove the filter jug when the product is installed close to the floor level and not result in any flooding.

The geometry of the reservoirs is designed with an angled base and centralised feed point for the pumps. This reduces sedimentation in the tank by removing static flow areas in the tank and creating a dynamic drainage environment that encourages particles to travel to the feed point and be removed by the pump along with any waste water.

The geometry and depth of the reservoirs is further designed to limit vortexing of the pumps which would otherwise reduce their ability to draw water into the pump and reduce their operational efficiency

The inlet 1201 and outlet 1219 of the unit 1100 are connected by a conduit 1220. A dispensing valve, 1221 is provided at the entrance to the conduit 1220. The dispensing valve opens at a predetermined pressure, so that if there is a fault in the unit and pressure builds up, the valve operates and effluent bypasses the filter section of the unit straight to the outlet. One-way valve 1222 is provided to prevent filtered effluent re-circulating and one-way valve 1223 is provided to prevent by-passing effluent to enter the reservoirs. In another embodiment of the design, the user can gain access to the bypass for maintenance, for example to remove a blockage.

An air valve 1224 is provided in the inlet to prevent the recirculation pump and/or the drainage pumps from drawing water out of a connected washing machine, to ensure that there is sufficient water left in the washing machine.

FIG. 16 shows the arrangement of the electronic control system of the unit, mounted on a PCB 1601. Two sensors are provided; i) a capacitive sensor in the inlet or other areas of the ducting depending on the control method and software logic, which detects the presence of effluent and ii) a pressure differential sensor that is arranged to measure the difference in pressure between the two sides of the mesh, by locating one part at the inlet side of the mesh and another part at the outlet side. The pressure differential sensor can be used to indicate a difference in pressure between each side of the mesh. This can be used to monitor the health of the system and can be used to provide feedback to the logic, such as indicating if the mesh is soon to blind over with debris and regeneration should be activated. A microswitch 1602 is provided that detects when the jug is fully located in the unit. Any other type of sensor may be used to detect mechanical movement, such as an IR sensor. If the jug is not located and the unit is switched on, then an alarm is sounded to alert the user to locate the jug before use. This can also be operated on a timer so that during maintenance the user is reminded to replace the jug and not leave the unit disassembled.

The capacitive sensor is a type of fluid sensor; any other type could be used, such as a float switch. A suitable capacitative sensor is XKC-Y25-NPN by True Sense®. A suitable pressure sensor is a ABPDRRV001PDSA3 by Honeywell.

The electronic system is arranged to operate the unit in numerous modes involving different combinations of sensors and software logic, to optimise the system operation or vary it for differing regional, user, functional or cost requirements. For example, only a capacitive sensor could be used (no pressure sensor) to reduce the number of components and cost. The following are examples of modes of use:

### Example 1—Capacitive Sensor and Pressure Sensor

### Active Filtering:

If the capacitive sensor indicates that there is effluent present at the inlet (i.e. that the washing machine is emptying) and the pressure sensor indicates that the mesh has blinded over, then the drainage pump is activated to drain the unit and the recirculation pump is activated to spray the mesh to remove the debris and regenerate the pressure consumption. Active filtering may run for a set time once it has been triggered.

### Passive Filtering:

If the pressure sensor indicates that the pressure differential is below a threshold and the capacitive sensor is triggered, then passive filtering is initiated. This is where the recirculation pump is turned off and only the drainage pump is operated.

### Drainage Cycle:

If the capacitive sensor indicates that effluent at the input has ceased, then the recirculation pump is operated after a delay, which could be around 100 seconds, to clean the mesh; this delay can be adjusted. Shortly after, for example 2 seconds, the drainage pump is operated to drain the system. The recirculation pump is then turned off after, for example, a further 3 seconds and then the drainage pump is turned off after, for example, 10 seconds. If the capacitive sensor detects input effluent then the drainage cycle is interrupted and the filtering mode is initiated again.

### Standby:

If the capacitive sensor is low, then the recirculation and drain pump are both turned off.

### Example 2—Capacitive Sensor Only

The capacitive sensor is provided on the inlet pipe. When water is detected the pumps are activated until water is not detected anymore. The pumps are programmed to overrun by a predetermined number of seconds to clean the mesh and drain the filter.

### Example 3—Capacitive Sensor with Current Monitoring on the Drainage Pump

The capacitive sensor is provided on the inlet pipe. When water is detected, the drain pump is turned on. If current on the drain pump is low while the fluid sensor is reading high, then the recirculation pump is turned on. The recirculation pump is turned off after a predetermined time while the drain pump is left on.

### Example 4—Integrated in Washing Machine—Pressure Sensor Only

The separator unit may be integrated into a washing machine or other textile processing apparatus. No fluid sensor is required as integration with the washing machine control logic enables the filter to know when water is being pumped into the filter. When fluid is pumped through the filter and the pressure sensor is low, the recirculation pump is not run, but the drain pump is activated. When fluid is being pumped through the filter and the pressure sensor is triggered, then the recirculation pump is run. The washing machine drain cycle can be paused at this point for a few seconds to increase the pressure consumption regeneration effectiveness.

The unit may be used to reduce the water consumption of an existing washing machine or other textile processing equipment, by recirculating the water from the output back into the washing machine. This is possible because the filter removes a high proportion of the debris from the effluent and is therefore very clean. A unit that is integrated into a washing machine could provide this functionality too.

The separator unit could be integrated into a washing machine and used to replace the conventional filter that is used to prevent debris from reaching and damaging the washing machine pump. Furthermore, by replacing an existing filter with the advanced filtering technology disclosed herein, a different washing machine pump could be used altogether, one that operates at a higher efficiency.

The pressure sensor may be monitored in a predictive manor to enable software to pre-empt when the filter is reaching saturation point and activate the regeneration before this time.

The pressure sensor may be monitored by the software to predict how much material the filter has captured and if the user should empty it. Additionally, by monitoring the pressure sensor data the bypass state can be determined. This information can then be displayed to the user. In an embodiment this might be through the interface on a retrofit filter or the user interface display of the washing machine.

In an embodiment where the filter is in communication with the washing machine the pressure sensor and the capacitive sensor may be omitted and the regen run based on timed intervals or other logic. It may be beneficial to start and stop the washing machine drain cycle during regeneration bursts to maximise the mesh cleaning power of the jets.

A separator may be provided where the inlet feeds the interior of the sieve structure and the outlet collects filtered effluent from the outside of the sieve structure.

The separator housing may be opened to empty the trap when the effluent has been drained.

An opening at the top of the sieve structure may be provided to avoid air locks.

An air inlet may be provided at the inlet of the separator to avoid syphoning all of the waste water out of a washing machine.

As an alternative to regenerating the pressure of the separator unit, a disposable cartridge may be provided. The part of the separator that contains the filtering element, i.e. the sieve structure, could be provided as a cartridge, that is removed and disposed of and replaced with a new one. Alternatively, the cartridge could be sent for cleaning and then re-used.

Wastewater expelled from textile factories is contaminated with microfibres and it is not guaranteed it will be filtered at municipal facilities. When these facilities exist, they may remove up to 98% of microplastics, however what escapes still equates to millions of microfibres every day. Microfibres removed from water may then be passed to the environment as “sewage sludge”, spread on agricultural land as fertiliser. Ultimately microfibres are passed as pollutants into the natural environment—they need to be stopped at source.

Wet-processing factories currently operate in a linear system, whereby microfibre resources are expelled as pollutants from the technical process into the biological environment. Use of the separator system described herein closes the loop into a continued cycle to retain the value of the microfibres within the technical process and stop damage to the biological environment.

An embodiment of the separator system can be retrofitted onto the existing wastewater outlet of wet-processing textile factories to enable microfibre capture at source before pollution of the natural environment can occur.

The separator system can be used to filter microplastics and other micropollutants from environmental drainage systems, such as roadside gullies. A lot of microplastics in the environment break down from larger items of plastic such as car tyres, road surfaces and road markings. After synthetic textiles, tyres are the largest source of microplastics and contain harmful materials such as mineral oils.

Catalytic converters are fitted on most cars and contain highly valuable materials such as platinum, palladium, copper and zinc. During use, small amounts of these metals are lost from cars and fragments are deposited on the road surface. While metal concentrations vary geographically, collection and recycling of these materials not only reduces environmental pollution but can also be a revenue stream in a circular economy.

A larger-scale embodiment of the invention can be applied to the treatment of effluent in Wastewater Treatment Plants. For example, the chamber of the separator could be 1 meter in diameter or 2 meters or greater.

Typical sewage networks are built along one of two designs:
i) Combined sewers. These collect surface water and sewage together, meaning all waste water passes through a Wastewater Treatment Plant (WWTP). During heavy rainfall, it is common for sewers to overflow, releasing untreated sewage and pollution into waterbodies.
ii) Separate sewers. These discharge surface water directly into waterbodies.

In both systems, roadside runoff, i.e. surface water from the roads, is released into the environment.

Most roadside gullies have drains located at regular points and these drains have a sediment “pot”, which lets heavy materials like gravel and sand settle to prevent blockage. These hold some micropollutants, but the majority of microplastics and valuable metals are too small and are not retained.

An embodiment of the separation system of the present invention can be retrofitted as an insert into the sediment pot of a drain to filter micropollutants at source. It is designed to fit existing gullies and to be emptied using a mobile vacuum pump.

The disclosure in the abstract is incorporated herein by reference.

In another embodiment the system can be used as part of a filtration system for maritime waste disposal. At sea shipping vessels dump wastewater contaminated from activities on the ship, which include microplastic from various sources. The filter system can be applied to filter this effluent prior to disposal and thus combat this pollution source.

1-15. (canceled)

16. A separator suitable for separating solid material from a fluid, the separator comprising:
a chamber with an inlet and an outlet,
a sieve structure forming a permeable barrier between the inlet and the outlet to filter the fluid, the sieve structure thus having an inlet side for unfiltered fluid and an outlet side for filtered fluid,
wherein the separator further comprises a filter pressure regeneration apparatus for dislodging filtered material from the sieve structure,
wherein the filter pressure regeneration apparatus comprises a conduit and a nozzle assembly having at least one cleaning jet directed towards the outlet side of the sieve structure, wherein the filter pressure regeneration apparatus is arranged to be fed from a cleaning fluid source,
wherein the sieve structure has a circular cross-section, and wherein a channel is formed between the chamber and the sieve structure such that in use the fluid is guided circumferentially around the sieve structure through the channel,
the separator further having a sensor arranged to sense a state of the separator, and wherein the cleaning fluid source is arranged to be activated in accordance with the output from the sensor.

17. The separator of claim 16, wherein the sensor is located at the inlet.

18. The separator of claim 16, wherein the sensor is located at the outlet.

19. The separator of claim 16, wherein a reservoir is provided below the chamber and the sensor is located in the reservoir.

20. The separator of claim 16, wherein the sensor is a fluid detector such as a float switch or a capacitive sensor.

21. The separator of claim 16, wherein the sensor is a pressure sensor.

22. The separator of claim 16, wherein the nozzle assembly comprises a plurality of cleaning nozzles that are rotatable around the central axis of the sieve structure.

23. The separator of claim 16, wherein a pump is arranged to recirculate the filtered fluid to the conduit of the filter pressure regeneration apparatus and/or drain the separator.

24. The separator of claim 16, wherein the cleaning fluid source is mains water controlled by an electronic valve.

25. A washing machine with a separator as claimed in claim 16.

26. A method of operating a separator of the type claimed in claims 1 to 9 comprising the steps of;
filtering a fluid through a sieve structure,
detecting at least one state of the separator,
performing an operation in dependence on the detected state of the separator.

27. The method of claim 16, wherein the state of the separator includes the pressure differential between the filtered side and the unfiltered side of the sieve structure.

28. The method of claim 16, wherein the operation includes operating a pressure regeneration apparatus that is arranged to spray the filtered side of the sieve structure with cleaning fluid to dislodge debris from the unfiltered side of the sieve structure.

29. The method of claim 28, wherein the operation includes operating a recirculation pump to recirculate a portion of the filtered fluid to the pressure regeneration apparatus.

30. The method of claim 28, wherein the operation includes operating a bypass system that includes an electronic valve.
